(19) United States
(12) Patent Application Publication
(10) Pub. No.: US 2020/0051104 A1
(43) Pub. Date: Feb. 13, 2020

(54) INTERACTIVE DIGITAL HUB FOR PROVIDING REAL-TIME AGGREGATED SUPPLEMENTAL RESOURCES

(71) Applicant: Bank of America Corporation, Charlotte, NC (US)

(72) Inventors: Victoria L. Dravneek, Charlotte, NC (US); Melissa Anne Almond, Caswell Beach, NC (US); Jinna Zevulun Kim, Charlotte, NC (US); Katherine Dintenfass, Lincoln, RI (US); John Allen Sellers, Kennett Square, PA (US); Matthew Murphy, Charlotte, NC (US); David A. Stetler, Wilmington, DE (US); Lisa D. Curry, Warwick, RI (US)

(73) Assignee: Bank of America Corporation, Charlotte, NC (US)

(21) Appl. No.: 16/371,879

(22) Filed: Apr. 1, 2019

Related U.S. Application Data
(60) Provisional application No. 62/717,419, filed on Aug. 10, 2018.

(51) Int. Cl. G06Q 30/02; G06Q 30/08; G06Q 50/26; G06Q 40/02

(52) U.S. Cl. CPC G06Q 30/0211; G06Q 40/02; G06Q 50/26; G06Q 30/08

(57) ABSTRACT

Embodiments of the present invention provide a system for providing an interactive real-time digital hub for processing supplemental resources. The present invention is configured to determine resource opportunities for a user as well as one or more customized supplemental resources associated with the resource opportunities. Next, a user interface of a computing device of the user is caused to display the resource opportunities and the user's activity is monitored to determine when the user has completed a resource opportunity. The associated supplemental resource is then provided to the user, and certain events related to the amount of the aggregate amount of supplemental resources can be executed in response to receiving a request for such execution by the user.

### CROSS-REFERENCE TO RELATED APPLICATION

This application is a non-provisional filing of U.S. Patent Application No. 62/717,419 filed Aug. 10, 2018, entitled “Interactive Digital Hub for Providing Real-Time Aggregated Supplemental Resources,” the contents of which are hereby incorporated by reference.

### FIELD

The present invention relates to providing an interactive digital hub for providing real-time aggregated supplemental resources.

### BACKGROUND

Supplemental resources provided by the present systems may not be utilized by the users before a predefined date. As such, the supplemental resources associated with the user may lapse and the user may lose the ability to use the lapsed supplemental resources. Therefore, there exists a need for a system to cause a user interface of user computing devices to dynamically display real-time aggregated supplemental resources and monitor the completion and execution of associated events.

### SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for providing an interactive real-time digital hub for processing supplemental resources. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

For sample, illustrative purposes, system environments will be summarized. The system may involve determining one or more resource opportunities available to a user. The system may also determine one or more customized supplemental resources associated with each of the one or more resource opportunities, wherein each of the one or more customized supplemental resources associated with each of the one or more resource opportunities comprises a universal supplemental resource amount or a supplemental resource that is directly related to an associated resource opportunity of the one or more resource opportunities. Next, the system may cause a user interface of a computing device of the user to display the one or more resource opportunities and the one or more customized supplemental resources associated with each of the one or more resource opportunities. The system can then monitor user activity data associated with each of the one or more resource opportunities to determine that a first resource opportunity of the one or more resource opportunities has been completed. In response to determining that the at least one of the one or more resource opportunities is complete, the system may transmit a first customize supplemental resource of the one or more customized supplemental resources to the computing device of the user. Next, the system can dynamically calculate a total aggregated amount of customized supplemental resources of a same resource type as the first customized supplemental resource, including an amount of the first customized supplemental resource. The system may then determine that the total aggregated amount of customized supplemental resources of the same resource type as the first customized supplemental resource meets a predetermined threshold amount for a new event, wherein the new event is associated with the customized supplemental resources of the same resource type as the first customized supplemental resource. In response, the system may cause the user interface of the computing device of the user to display a notification comprising a selectable icon for accepting the new event. Finally, the system can execute the new event in response to receiving an indication that the selectable icon for accepting the new event has been selected.

In some embodiments of the system, the system may additionally be configured to determine that multiple supplemental resources of the one or more customized supplemental resources are optionally available with the first resource opportunity. In some such embodiments, the system may then cause the user interface of the computing device of the user to display selectable icons associated with each of the multiple supplemental resources that are optionally available with the first resource opportunity. Next, the system may receive, from the user interface of the computing device of the user, user input of a selection of a first selectable icon of the displayed selectable icons. Finally, the system may designate an associated supplemental resource of the multiple supplemental resources that is optionally available with the first resource opportunity as the first customized supplemental resource in response to receiving the user input of the selection of the first selectable icon.

For some embodiments of the system, the at least one of the one or more resource opportunities available to the user comprise a transaction at a merchant with an affiliation with a charity, wherein at least one of the one or more customized supplemental resources associated with the transaction at the merchant with the affiliation with the charity comprises a donation amount to the charity, wherein the new event comprises a transfer of the donation amount from the merchant to the charity, and wherein the predetermined threshold amount for the new event comprises any amount greater than zero.

In other embodiments of the system, the at least one of the one or more resource opportunities available to the user comprise participation in an educational course associated with a product or service of a merchant or a managing entity, wherein at least one of the one or more customized supplemental resources associated with the participation in the educational course comprises a transaction discount offer or a decreased interest rate associated with the product or service of the merchant or the managing entity, wherein the new event comprises applying the transaction discount offer or the decreased interest rate to the product or service of the merchant or the managing entity, and wherein the predetermined threshold amount for the new event comprises any non-zero discount offer amount or decreased interest rate amount.

The one or more customized supplemental resources associated with the first resource opportunity may, in some embodiments, comprise collective supplemental resources that can be aggregated between the user and other members of a group that the user is in, wherein the total aggregated amount of customized supplemental resources of the same resource type as the first customized supplemental resource additionally includes amounts of supplemental resources acquired by the other members of the group that the user is in.

The new event of the system may comprise a bid for an offered product or service. Additionally or alternatively, the one or more resource opportunities available to the user may comprise a task associated with an internet of things device, wherein the task comprises a measurable fitness achievement, a measurable energy consumption achievement, or a measureable geographic location-based achievement. Finally, in some embodiments of the system, the one or more resource opportunities available to the user may comprise a period of time associated with increased values for the one or more customized supplemental resources.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, where:

FIG. 1 illustrates supplemental resources processing system environment, in accordance with embodiments of the invention;

FIG. 2 illustrates an additional or alternative supplemental resources processing system environment, in accordance with embodiments of the invention;

FIG. 3 provides a block diagram illustrating the managing entity system of FIG. 1, in accordance with embodiments of the invention;

FIG. 4 provides a block diagram illustrating the supplemental resources processing system of FIG. 1, in accordance with embodiments of the invention;

FIG. 5 provides a block diagram illustrating the computing device of FIG. 1, in accordance with embodiments of the invention; and

FIG. 6 presents a high level process flow illustrating a process for providing an interactive real-time digital hub for processing supplemental resources, in accordance with embodiments of the invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Many of the example embodiments and implementations described herein contemplate interactions engaged in by a user with a computing device and/or one or more communication devices and/or secondary communication devices.

In accordance with embodiments of the invention, the terms “resource entity system” or “entity system” or “resource entity” may include any organization that processes financial transactions including, but not limited to, banks, credit unions, savings and loan associations, card associations, settlement associations, investment companies, stock brokerages, asset management firms, insurance companies and the like. In some embodiments, a “financial institution” as used herein may include commercial banks, thrifts, federal and state savings banks, savings and loan associations, credit unions, investment companies, insurance companies and the like. In some embodiments, the financial institution may allow a customer to establish an account with the financial institution. In some embodiments, the system of the present invention may be embedded into a resource entity system. In alternate embodiments, the system of the present invention (i.e., supplemental resources processing system) may be an independent system in communication with the resource entity system.

In accordance with embodiments of the present invention, an “account” or “resource pool” may be the relationship that the customer has with the financial institution. Examples of accounts include a deposit account, such as a transactional account (e.g. a banking account), a savings account, an investment account, a money market account, a time deposit, a demand deposit, a pre-paid account, a credit account, a non-monetary customer profile that includes only personal information associated with the customer, or the like. An account may be associated with and/or maintained by a financial institution.

In some embodiments of the present invention, a “third party entity system” may be any other entities including, but not limited to other resource entities (e.g., financial institutions) merchants who are customers of the resource entity, or the like.

In some embodiments, a “user” may be a financial institution customer (e.g., an account holder or a person who has an account (e.g., banking account, credit account, or the like)). In some embodiments, a “user” may be a potential customer of the financial institution. In some embodiments, a “user” may be a customer of a third party entity.

As described herein, the term “supplemental resources” may be any rewards, incentives, reduction of interchange fees, a score different from a credit score, or the like provided by the resources entities, third party entities, or the like.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

Presently supplemental resources provided by the entity may not be combined with other supplemental resources provided by another entity. As such, the present system provides a real-time interactive digital hub for allowing the user to make better use of the supplemental resources provided by one or more entities. Moreover, the present system also provides one or more new methods to provide supplemental resources to the users based on one or more actions provided by the users.

As described herein, a digital hub for a rewards program is provided to users of a managing entity (e.g., a financial institution). The digital hub serves as a unified platform for all rewards associated with the financial institution and/or merchants with relationships with the financial institution. Resource opportunities are determined or identified for a user (e.g., based on user information, historical information, transaction history information, and/or the like), and may be any type of rewardable activity that a user can complete to receive a reward. Examples of resource opportunities include purchases with a particular merchant and/or of a particular product or service, enrollment in a service of a merchant or the financial institution, participation in educational programs, gamification activities, trackable achievements (e.g., fitness, energy consumption, travel, or the like), referrals or influencer actions, and promotional increased rewards over a particular period of time. Certain supplemental resources (e.g., reward points) for each of these resource opportunities are indicated alongside the resource opportunities within the display of the digital hub, along with award amounts and progress toward reward goals.

Some examples of reward goals that can be accessed based on an aggregate amount of reward points includes, but is not limited to, discounts, cash back, lower interest rates, travel rewards, charitable donations, experiences, and improved service levels. The digital hub provides a single location for the identification of available rewards, viewing reward tracking metrics, and selecting reward types and goals. The digital hub includes capabilities to combine different reward types into a universal reward program. A user can customize rewards, tailoring the reward types and reward amounts for certain resource opportunities. Communication with other users is available, which may facilitate pooling rewards to meet a collective goal. Reward goals may automatically be executed when reward points are met, if approved by the user.

This digital hub for rewards and other supplemental resources can integrate the use of internet of things (IoT) devices to identify resource opportunities and/or monitor a status of certain resource opportunity activities. The digital hub may also facilitate a user's participation in educational programs, like financial planning, with reward goals of lowered interest rates on loans. Furthermore, the digital hub can include the capability to convert different types of reward points into a universal reward type (or an identified reward type) at the user's request.

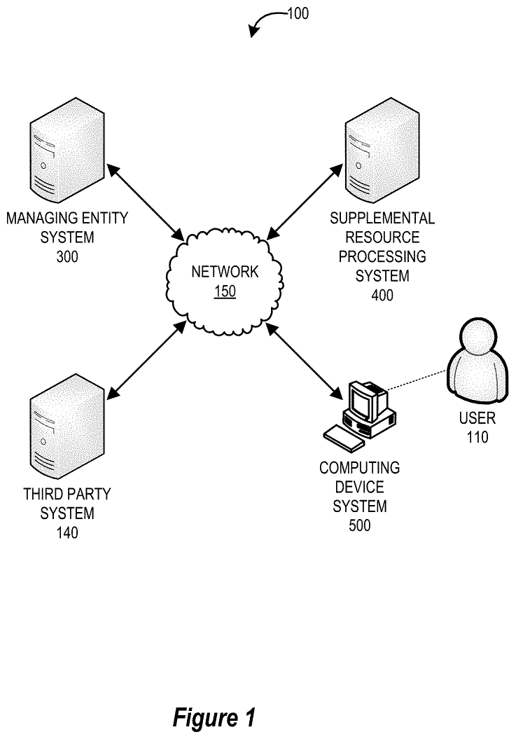

FIG. 1 provides a block diagram illustrating a system environment 100 for providing an interactive real-time digital hub for processing supplemental resources, in accordance with an embodiment of the invention. As illustrated in FIG. 1, the environment 100 includes a managing entity system 300, a supplemental resource processing system 400, a one or more computing device systems 500, and one or more third party systems 140. One or more users 110 may be included in the system environment 100. In some embodiments, the user(s) 110 of the system environment 100 may be customers of the managing entity associated with the managing entity system 300. For example, a user 110 may have a financial account with the managing entity system 300. Additionally, the user 110 may be a customer or is otherwise affiliated with (e.g., as a donor, member, or the like) of a merchant entity, a non-profit entity, and education entity, an organization, or the like, which may be represented herein as the third party system 140. In some embodiments, multiple users like the user 110 may be included in the system environment 100, where multiple users are accessing a digital hub for supplemental resource processing, such that the multiple users can aggregate their individual pools of supplemental resources to achieve a larger resource goal. In such embodiments, each of the multiple users may have their own computing device system like the computing device system 500 to be able to communicate with the other systems in the system environment 100.

The managing entity system 300, the supplemental resource processing system 400, the computing device system 500, and/or the third party system 140 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet.

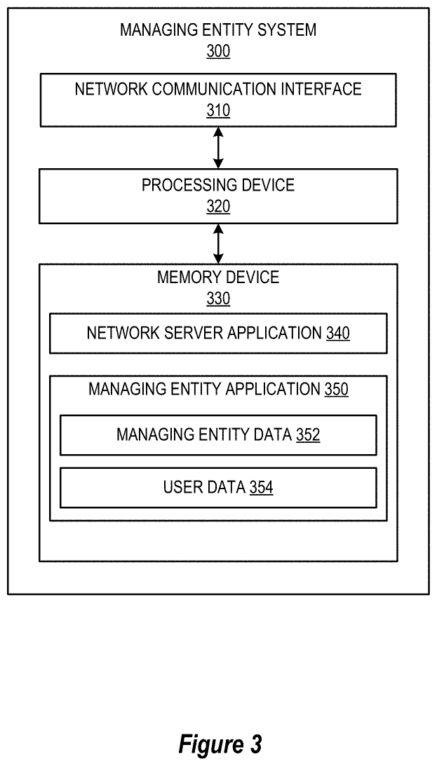

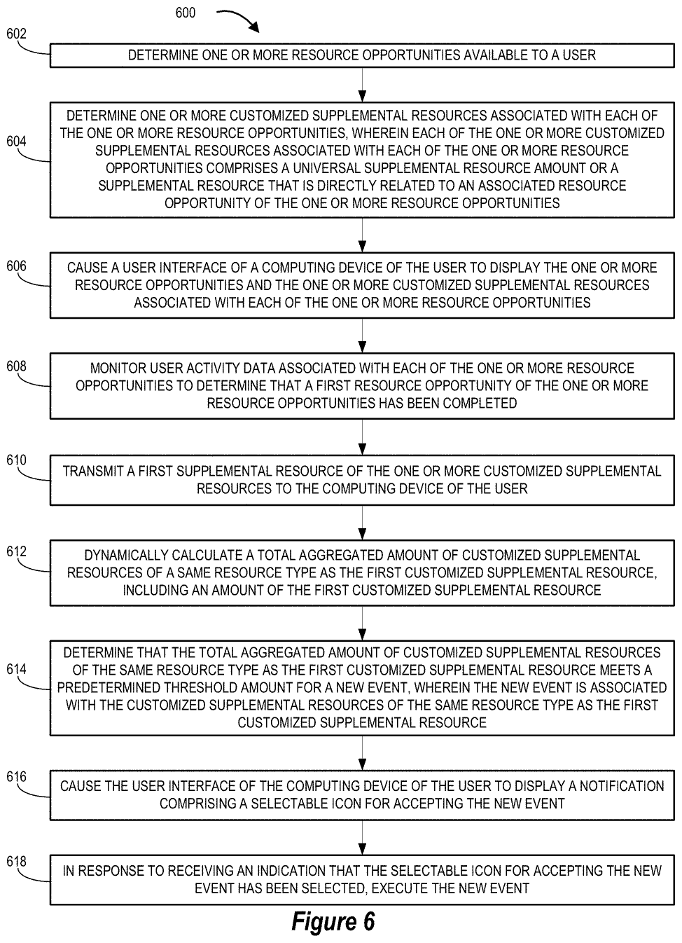

The managing entity system 300 may be a system owned or otherwise controlled by a managing entity to perform one or more process steps described herein. In some embodiments, the managing entity is a financial institution. In general, the managing entity system 300 is configured to communicate information or instructions with the supplemental resource processing system 400, the computing device system 500, and/or the third party system 140 across the network 150. For example, the managing entity system 300 may perform one or more of the steps described with respect to FIG. 6. Of course, the managing entity system 300 may be configured to perform (or instruct other systems to perform) one or more other process steps described herein. The managing entity system 300 is described in more detail with respect to FIG. 3.

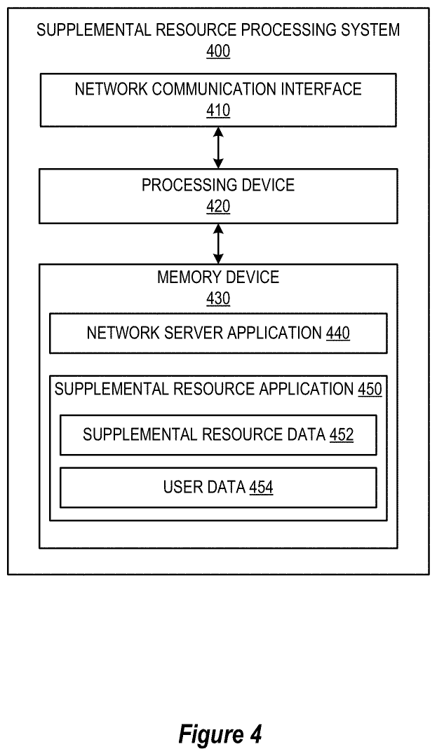

The supplemental resource processing system 400 may be a system owned or controlled by the managing entity and/or a third party that specializes in identifying, providing, tracking, and monitoring resource opportunities, as well as to track the accumulation of supplemental resources, customize supplemental resources based on user input, and execute new events (i.e., actions based on reward goals) in response to predetermined thresholds of supplemental resources being met. In general, the supplemental resource processing system 400 is configured to communicate information or instructions with the managing entity system 300, the computing device system 500, and/or the third party system 140 across the network 150. In some embodiments, at least a portion of the supplemental resource processing system 400 is a component of the managing entity system 300. In some embodiments, at least a portion of the supplemental resource processing system 400 is separate from the managing entity system 300, but is controlled by signals sent from the managing entity system 300. For example, the supplemental resource processing system 400 may perform one or more of the process steps described with respect to FIG. 6, or may be instructed by the managing entity system 300 to perform such steps. Of course, the supplemental resource processing system 400 may be configured to perform (or instruct other systems to perform) one or more other process steps described herein. The supplemental resource processing system 400 is described in more detail with respect to FIG. 4.

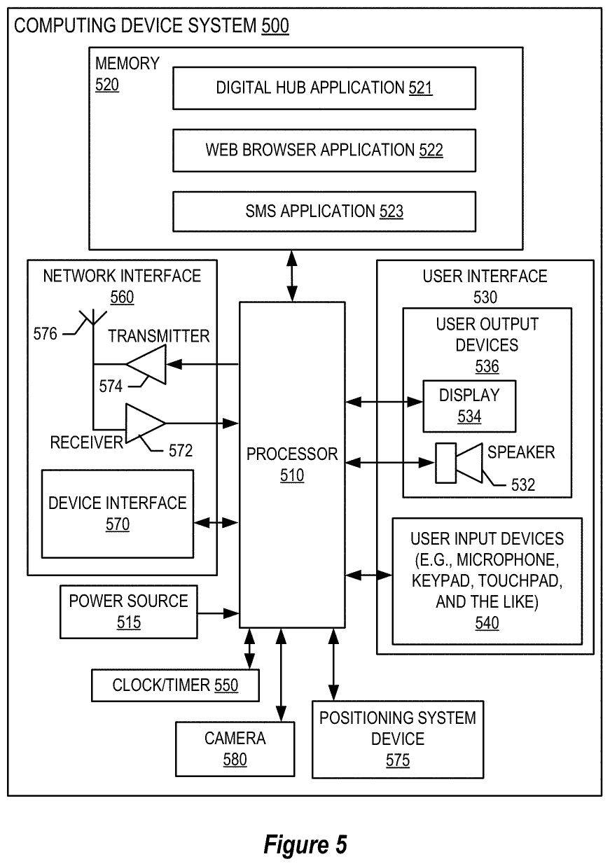

The computing device system 500 may be a system owned or controlled by the managing entity and/or a third party that specializes in facilitating user interaction through the use of user interfaces to display information, receive user input, and communicate messages to and from other components of the system environment 100 via the network 150. In general, the computing device system 500 is configured to communicate information or instructions with the managing entity system 300, the supplemental resource processing system 400, and/or the third party system 140 across the network 150. For example, the computing device system 500 may include a digital hub application that permits the associated user 110 to access, manage, monitor, and otherwise interact with the supplemental resource processing system 400 and/or the managing entity system 300 for the purpose of utilizing a supplemental resource or other rewards program. Of course, the computing device system 500 may be configured to perform (or instruct other systems to perform) one or more other process steps described herein. The computing device system 500 is described in more detail with respect to FIG. 5.

As described above, the third party system 140 may be any system that facilitates communication between the other systems of the system environment 100 to entities like a merchant entity, a regulatory entity, a supplemental resource tracking entity, and the like.

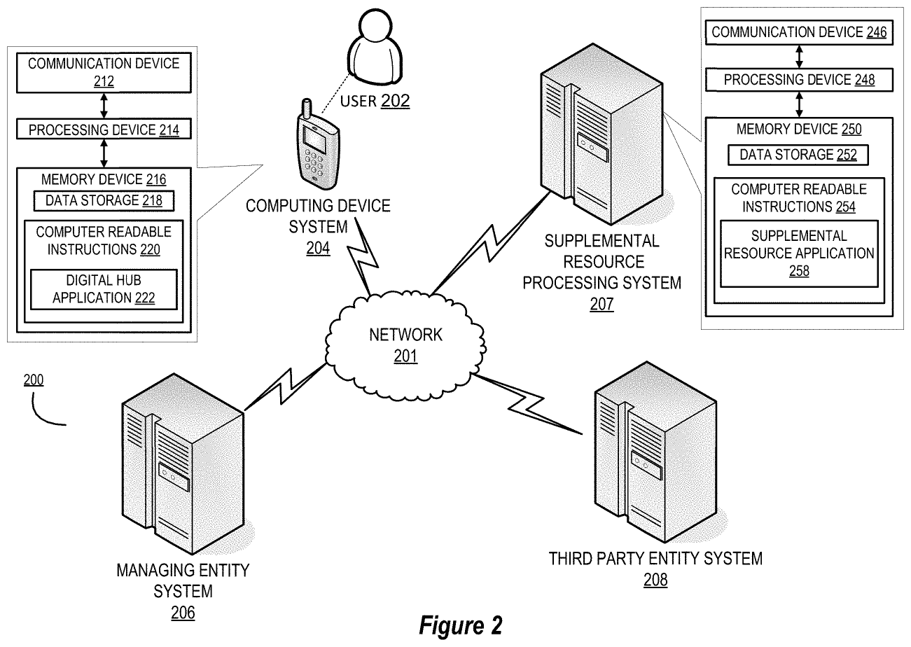

FIG. 2 illustrates another supplemental resources processing system environment 200, in accordance with embodiments of the present invention. FIG. 2 provides the system environment 200 for providing an interactive real-time digital hub for providing supplemental resources to the users on one or more computing devices.

As illustrated in FIG. 2, the supplemental resource processing system 207 is operatively coupled, via a network 201 to the computing device system 204, the third party entity systems 208, and to the managing entity system 206. In this way, the supplemental resource processing system 207 can send information to and receive information from the computing device system 204, third party entity system 208, and the managing entity system 206. FIG. 2 illustrates only one example of an embodiment of the system environment 200, and it will be appreciated that in other embodiments one or more of the systems, devices, or servers may be combined into a single system, device, or server, or be made up of multiple systems, devices, or servers. In some embodiments, the supplemental resource processing system 207 may be owned and maintained by the entity associated with the entity system. In some embodiments, the supplemental resource processing system 207 may be a part of the managing entity system 206. In some embodiments, the supplemental resource processing system 207 may be an independent system.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 may be a customer of the entity system. FIG. 2 also illustrates a computing device system 204. The computing device system 204 may be, for example, a desktop personal computer, business computer, business system, business server, business network, a mobile system, such as a cellular phone, smart phone, personal data assistant (PDA), laptop, or the like. The computing device system 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the managing entity system 206, the third party entity system 208, and the supplemental resource processing system 207. As such, the communication device 212 generally comprises a modem, server, or other device for communicating with other devices on the network 201.

The computing device system 204 comprises computer-readable instructions 220 and data storage 218 stored in the memory device 216, which in one embodiment includes the computer-readable instructions 220 of a digital hub application 222. In some embodiments, the digital hub application 222 allows a user 202 to communicate with the supplemental resource processing system 207, the managing entity system 206, and the third party entity system 208. In some embodiments, the digital hub application 222 may be provided by the supplemental resource processing system 207. In some other embodiments, the digital hub application 222 may be provided by the managing entity system 206 which comprises one or more add-ons or plugins provided by the supplemental resource processing system 207.

As further illustrated in FIG. 2, supplemental resource processing system 207 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the third party entity system 208, the managing entity system 206, and the computing device system 204. As such, the communication device 246 generally comprises a modem, server, or other device for communicating with other devices on the network 201.

As further illustrated in FIG. 2, the supplemental resource processing system 207 comprises computer-readable instructions 254 stored in the memory device 250, which in one embodiment includes the computer-readable instructions 254 of a supplemental resource application 258. In some embodiments, the memory device 250 includes data storage 252 for storing data related to the system environment 200, but not limited to data created and/or used by the supplemental resource application 258.

In one embodiment of the supplemental resource processing system 207 the memory device 250 stores a supplemental resource application 258. Furthermore, the supplemental resource processing system 207, using the processing device 248 codes certain communication functions described herein. In one embodiment, the computer-executable program code of an application associated with the supplemental resource application 258 may also instruct the processing device 248 to perform certain logic, data processing, and data storing functions of the application. In some embodiments, the supplemental resource application 258 of the supplemental resource processing system 207 comprises one or more instructions to perform one or more processes described herein. The processing device 248 is configured to use the communication device 246 to communicate with and ascertain data from the managing entity system 206, the third party entity system 208, and/or computing device system 204.

As illustrated in FIG. 2, the managing entity system 206 is connected to the computing device system 204, the third party entity system 208, and supplemental resource processing system 207. The managing entity system 206 has the same or similar components as described above with respect to the computing device system 204 and the supplemental resource processing system 207. The managing entity system 206 may include an entity application which may be an online banking application, digital wallet application or the like. In some embodiments, the interactive digital hub provided by the supplemental resource processing system 207 may be a part of the entity application. The managing entity system 206 may be any financial institution which provided one or more supplemental resource to the customers (e.g., user 202) upon performing one or more actions.

As illustrated in FIG. 2, the third party entity system 208 is connected to the supplemental resource processing system 207, computing device system 204, and managing entity system 206. The third party entity system 208 has the same or similar components as described above with respect to the computing device system 204 and the managing entity system 206. While only one third party entity system 208 is illustrated in FIG. 2, it is understood that multiple third party entity systems may make up the system environment 200. The supplemental resource processing system 207 may communicate with the third party entity system 208 to provide one or more supplemental resources to the users. In some embodiments, the supplemental resource processing system 207 may communicate with the third party entity system 208 to allow the user 202 to use the supplemental resources provided by the managing entity system 206. The third party entity system 208 may be a merchant system, a regulatory system, a third party entity with a rewards or other supplemental resource program that can be integrated with the supplemental resource program of the managing entity, or the like.

It is understood that the servers, systems, and devices described herein illustrate one embodiment of the invention. It is further understood that one or more of the servers, systems, and devices can be combined in other embodiments and still function in the same or similar way as the embodiments described herein. The third party entity system 208 may generally include a processing device communicably coupled to devices as a memory device, output devices, input devices, a network interface, a power source, one or more chips, and the like. The third party entity system 208 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like. The memory device may store any of a number of applications or programs which comprise computer-executable instructions/code executed by the processing device to implement the functions of the third party entity system 208 described herein.

FIG. 3 provides a block diagram illustrating the managing entity system 300, in greater detail, in accordance with embodiments of the invention. As illustrated in FIG. 3, in one embodiment of the invention, the managing entity system 300 includes one or more processing devices 320 operatively coupled to a network communication interface 310 and a memory device 330. In certain embodiments, the managing entity system 300 is operated by a first entity, such as a financial institution, while in other embodiments, the managing entity system 300 is operated by an entity other than a financial institution.

It should be understood that the memory device 330 may include one or more databases or other data structures/repositories. The memory device 330 also includes computer-executable program code that instructs the processing device 320 to operate the network communication interface 310 to perform certain communication functions of the managing entity system 300 described herein. For example, in one embodiment of the managing entity system 300, the memory device 330 includes, but is not limited to, a network server application 340, a managing entity application 350 which includes at least managing entity data 352 and user data 354, and other computer-executable instructions or other data. The computer-executable program code of the network server application 340 and/or the managing entity application 350 may instruct the processing device 320 to perform certain logic, data-processing, and data-storing functions of the managing entity system 300 described herein, as well as communication functions of the managing entity system 300.

In one embodiment, the managing entity application 350 includes the managing entity data 352 and the user data 354. The managing entity data 352 may comprise information about the managing entity, resource opportunities associated with the managing entity (including resource opportunities with merchants that have a relationship with the managing entity), and the like. The user data 354 may include information about particular users associated with the managing entity (e.g., customers of the managing entity, members of the managing entity, or the like), and may include user preferences, user transaction histories, user location information, user device information, user account information, and the like.

The network server application 340 and the managing entity application 350 are configured to invoke or use the managing entity data 352, the user data 354, and the like when communicating through the network communication interface 310 with the supplemental resource processing system 400, the computing device system 500, and/or the third party system 140 of FIG. 1.

FIG. 4 provides a block diagram illustrating the supplemental resource processing system 400, in greater detail, in accordance with embodiments of the invention. As illustrated in FIG. 4, in one embodiment of the invention, the supplemental resource processing system 400 includes one or more processing devices 420 operatively coupled to a network communication interface 410 and a memory device 430. In certain embodiments, the supplemental resource processing system 400 is operated by a first entity, such as a financial institution, while in other embodiments, the supplemental resource processing system 400 is operated by an entity other than a financial institution.

It should be understood that the memory device 430 may include one or more databases or other data structures/repositories. The memory device 430 also includes computer-executable program code that instructs the processing device 420 to operate the network communication interface 410 to perform certain communication functions of the supplemental resource processing system 400 described herein. For example, in one embodiment of the supplemental resource processing system 400, the memory device 430 includes, but is not limited to, a network server application 440, a supplemental resource application 450 which includes supplemental resource data 452 and user data 454, and other computer-executable instructions or other data. The computer-executable program code of the network server application 440, and/or the supplemental resource application 450 may instruct the processing device 420 to perform certain logic, data-processing, and data-storing functions of the supplemental resource processing system 400 described herein, as well as communication functions of the supplemental resource processing system 400.

In one embodiment, the supplemental resource application 450 includes the supplemental resource data 452 and the user data 454. The supplemental resource data 452 may comprise information about supplemental resources and amounts that are available to certain users in response to the completion of certain resource opportunities, total amounts of each type of supplemental resource that a particular user or group of users has accumulated, resource goals (including predetermined threshold amounts) associated with the supplemental resources, universal reward values, and the like. The user data may include information about a user's selection of a type of supplemental resource to be awarded to the user in response to the user completing a resource opportunity, user transaction information, user device information, user charity affiliation information, and the like.

The supplemental resource application 450, along with the managing entity application 350 of the managing entity system 300 may transmit control signals to one or more user computing devices to cause those devices to display a unified digital hub associated with the resource opportunities, the supplemental resources associated with those resource opportunities, and supplemental resource goals for new events, where the information presented via the unified digital hub is updated in real-time as the user progresses through a resource opportunity and accumulates supplemental resources.

FIG. 5 provides a block diagram illustrating a computing device system 500 of FIG. 1 in more detail, in accordance with embodiments of the invention. In one embodiment of the invention, the computing device system 500 is a mobile telephone. However, it should be understood that a mobile telephone is merely illustrative of one type of computing device system 500 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned. In some embodiments, a user may be associated with multiple computing device systems. For example, a first computing device system may be used by a user to view and manage a digital hub for resource opportunities and supplemental resources, while another computing device system comprises an IoT device associated with the user that is used to track the user's progress toward completing a resource opportunity to receive a set amount of supplemental resources.

Some embodiments of the computing device system 500 include a processor 510 communicably coupled to such devices as a memory 520, user output devices 536, user input devices 540, a network interface 560, a power source 515, a clock or other timer 550, a camera 580, and a positioning system device 575. The processor 510, and other processors described herein, generally include circuitry for implementing communication and/or logic functions of the computing device system 500. For example, the processor 510 may include a digital signal processor device, a microprocessor device, and various analog to digital converters, digital to analog converters, and/or other support circuits.

Control and signal processing functions of the computing device system 500 are allocated between these devices according to their respective capabilities. The processor 510 thus may also include the functionality to encode and interleave messages and data prior to modulation and transmission. The processor 510 can additionally include an internal data modem. Further, the processor 510 may include functionality to operate one or more software programs, which may be stored in the memory 520. For example, the processor 510 may be capable of operating a connectivity program, such as a web browser application 522. The web browser application 522 may then allow the computing device system 500 to transmit and receive web content, such as, for example, location-based content and/or other web page content, according to a Wireless Application Protocol (WAP), Hypertext Transfer Protocol (HTTP), and/or the like.

The processor 510 is configured to use the network interface 560 to communicate with one or more other devices on the network 150. In this regard, the network interface 560 includes an antenna 576 operatively coupled to a transmitter 574 and a receiver 572 (together a “transceiver”). The processor 510 is configured to provide signals to and receive signals from the transmitter 574 and receiver 572, respectively. The signals may include signaling information in accordance with the air interface standard of the applicable cellular system of a wireless network. In this regard, the computing device system 500 may be configured to operate with one or more air interface standards, communication protocols, modulation types, and access types. By way of illustration, the computing device system 500 may be configured to operate in accordance with any of a number of first, second, third, and/or fourth-generation communication protocols and/or the like.

For example, the computing device system 500 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with SGPP protocols and/or the like. The computing device system 500 may also be configured to operate in accordance with non-cellular communication mechanisms, such as via a wireless local area network (WLAN) or other communication/data networks.

As described above, the computing device system 500 has a user interface that is, like other user interfaces described herein, made up of user output devices 536 and/or user input devices 540. The user output devices 536 include a display 530 (e.g., a liquid crystal display or the like) and a speaker 532 or other audio device, which are operatively coupled to the processor 510.

The user input devices 540, which allow the computing device system 500 to receive data from a user such as the user 110, may include any of a number of devices allowing the computing device system 500 to receive data from the user 110, such as a keypad, keyboard, touch-screen, touchpad, microphone, mouse, joystick, other pointer device, button, soft key, and/or other input device(s). The user interface may also include a camera 580, such as a digital camera.

The computing device system 500 may also include a positioning system device 575 that is configured to be used by a positioning system to determine a location of the computing device system 500. For example, the positioning system device 575 may include a GPS transceiver. In some embodiments, the positioning system device 575 is at least partially made up of the antenna 576, transmitter 574, and receiver 572 described above. For example, in one embodiment, triangulation of cellular signals may be used to identify the approximate or exact geographical location of the computing device system 500. In other embodiments, the positioning system device 575 includes a proximity sensor or transmitter, such as an RFID tag, that can sense or be sensed by devices known to be located proximate a merchant or other location to determine that the computing device system 500 is located proximate these known devices. The positioning system device 575 may play a crucial role in transmitting location information associated with the computing device system 500 for determining when the computing device system 500 is in at or is in close proximity to a particular location associated with a resource opportunity.

The computing device system 500 further includes a power source 515, such as a battery, for powering various circuits and other devices that are used to operate the computing device system 500. Embodiments of the computing device system 500 may also include a clock or other timer 550 configured to determine and, in some cases, communicate actual or relative time to the processor 510 or one or more other devices.

The computing device system 500 also includes a memory 520 operatively coupled to the processor 510. As used herein, memory includes any computer readable medium (as defined herein below) configured to store data, code, or other information. The memory 520 may include volatile memory, such as volatile Random Access Memory (RAM) including a cache area for the temporary storage of data. The memory 520 may also include non-volatile memory, which can be embedded and/or may be removable. The non-volatile memory can additionally or alternatively include an electrically erasable programmable read-only memory (EEPROM), flash memory or the like.

The memory 520 can store any of a number of applications which comprise computer-executable instructions/code executed by the processor 510 to implement the functions of the computing device system 500 and/or one or more of the process/method steps described herein. For example, the memory 520 may include such applications as a conventional web browser application 522 and/or a digital hub application 521 (or any other application provided by the managing entity system 300). These applications also typically instructions to a graphical user interface (GUI) on the display 530 that allows the user 110 to interact with the computing device system 500, the managing entity system 300, and/or other devices or systems. In one embodiment of the invention, when the user 110 decides to enroll in a digital hub application 521 program, the user 110 downloads, is assigned, or otherwise obtains the digital hub application 521 from the managing entity system 300, or from a distinct application server (e.g., from the supplemental resource processing system 400). In other embodiments of the invention, the user 110 interacts with the managing entity system 300 or the supplemental resource processing system 400 via the web browser application 522 in addition to, or instead of, the digital hub application 521.

The memory 520 of the computing device system 500 may comprise a Short Message Service (SMS) application 523 configured to send, receive, and store data, information, communications, alerts, and the like via a wireless telephone network.

The memory 520 can also store any of a number of pieces of information, and data, used by the computing device system 500 and the applications and devices that make up the computing device system 500 or are in communication with the computing device system 500 to implement the functions of the computing device system 500 and/or the other systems described herein. For example, the memory 520 may include such data as supplemental resource accumulation data, and the like.

Referring now to FIG. 6, a flowchart is provided to illustrate one embodiment of a process 600 for providing an interactive real-time digital hub for processing supplemental resources, in accordance with embodiments of the invention. In some embodiments, the process 600 may include block 602, where the system determines one or more resource opportunities available to a user.

Resource opportunities may be any opportunity to earn universal supplemental resources for performing one or more actions such as completing a transactions, donating to a charity, completing a course, getting certified in educational programs, enrolling in supplemental resource programs provided by the entity, opening a new resource pool (e.g., mortgage account, or the like), referring at least one other user (e.g., family or friends) to enroll in programs or to open a new resource pool, achieving fitness goals, providing user information, validating existing user information, volunteering at a charity, shopping at a particular merchant who may be a customer of the entity, spending time at a merchant store, saving towards a goal, attending an event associated with the entity or with a merchant associated with the entity, enrolling in auto pay, performing one or more actions on social media platforms for promoting an event or a program, scheduling an appointment at a financial center and keeping the appointments, teaching at least one other user about education programs provided by the entity, using a virtual assistant at the financial center or in an online application, and bidding on a product. Supplemental resources may include universal rewards which may be combined with other rewards associated with other accounts of the user, a universal score different from a credit score which is associated with the rewards, incentives, or the like.

In some embodiments, the system may determine one or more resource opportunities dynamically based on identifying that the user is performing an action. For example, the system may identify that the user has scheduled an appointment at the financial center and may identify the resource opportunity as scheduling a follow up appointment. In another example, the system may identify that the user has purchased an Internet of Things (IoT) device and the system may identify the resource opportunity as associated the IoT device with the resource pool of the user. In a case where the IoT device is a refrigerator, the system may transmit a notification to the user device via the dynamic hub to link the credit account to the refrigerator for making purchases. In such embodiment, the system may also determine a resource opportunity based on a shopping list generated by the refrigerator and may transmit a notification to the user device to purchase the products in the shopping list at a particular merchant to earn a reward.

In another example, the system may identify that the user has downloaded a fitness application on the user device and has set some goals, the system may transmit a notification to the user device via the digital hub that the user can earn rewards upon reaching the fitness goal. In another example, the system may identify that the user completed a certification program via the digital hub provided by the system and may transmit a notification to the user device to complete another certification. In such an embodiment, the system may also transmit a notification to share the certification program with one or more contacts. In another such embodiment, the system may also notification to rate the certification program based on identifying that the user completed the certification program.

In another example, the system may identify that the user has certain amount of rewards or reward points, compare the rewards points to one or more users having common characteristics, and may transmit a notification to the user device to perform one or more transactions to increase the reward points to reach a first place or second place in order to earn additional rewards. In one example, the system may identify that a bidding event is being organized by the entity or merchant associated with the entity and may transmit a notification to the user device to participate in the bidding event for earning a reward.

In one example, the system may identify that a customer of the entity is participating in raising money for an event or charity, the system may transmit a notification to the participate in the event or charity by contributing or by sharing the event or charity to one or more contacts to earn rewards. In yet another example, the system may identify that the user has entered a store associated with a merchant who is a customer of the entity and may transmit a notification to the user device to spend at least fifteen minutes at the store to earn a reward or to talk to a customer service representative about a particular product to earn a reward.

The resource opportunities available to the user may comprise tasks associated with an IoT device or a wearable smart device, wherein the task comprises a measurable fitness achievement (e.g., as determined by a wearable smart device that tracks fitness parameters like distance travelled or heart rate over time), a measurable energy consumption achievement (e.g., as determined by a smart thermostat device), a need to replace a product (e.g., as determined by a smart refrigerator, a smart local energy monitoring device, or the like) or a measureable geographic location-based achievement (e.g., as determined by a monitoring device in a vehicle or on a wearable smart device).

In some instances, the resource opportunities available to the user may comprise a set period of time associated with increased values for the one or more customized supplemental resources. For example, there may be a day or set of hours within a day dedicated to rewards that is promoted to the user, where rewards earned on that time period are given a greater value than normal (i.e., outside of this designated period of time).

In some embodiments, the process 600 includes block 604, where the system determines one or more customized supplemental resources associated with each of the one or more resource opportunities, wherein each of the one or more customized supplemental resources associated with each of the one or more resource opportunities comprises a universal supplemental resource amount or a supplemental resource that is directly related to an associated resource opportunity of the one or more resource opportunities.

In an embodiment where the resource opportunity is getting certified in an educational programs about maintaining an average balance, financial planning, mortgage planning, or the like, the system may determine the customized supplemental resources as adding points to a universal score for completing the certification, where the universal score may be used by the user to get a reduced interest rate on a mortgage, reduction in the down payment amount, loan approval when the user does not have credit history, reduction of annual fee, or the like.

In another embodiment, where the resource opportunity is donating to a charity while performing a transaction, the system may determine the supplemental resource as reducing the interchange fee. In another embodiment, where the resource opportunity is donating to a charity affiliated to the entity or to a merchant who is a customer of the entity, the system may determine the supplemental resource as a matching contribution from the entity and/or the merchant.

In an embodiment, where the resource opportunity is achieving a predetermined threshold of total value or number of supplemental resources achieved over a predetermined amount of time, the system may determining the supplemental resource as a higher tier reward. In some embodiments, the supplemental resources may be universal supplemental resource points which may be used by the user to perform one or more transactions such as donating to charity, donating to a charity in a wedding registry, where the wedding registry is provided by the entity, purchasing a particular product, or the like.

In some embodiments, the customized supplemental resource may be a product or service offered by one or more merchants who are customers of the entity. For example, the supplemental resource may be a free cup of coffee. In another example, the supplemental resource may be a free car wash.

The one or more customized supplemental resources may comprise collective supplemental resources that can be aggregated between the user and other members of a group that the user is in. For example, the user may be part of a family, a nonprofit organization, a work organization, a club, or the like, and the system can permit the aggregation of supplemental resources together for the collective use of the group. In this way, a group may be able to aggregate enough supplemental resources to donate a trip or other experience to a charitable organization, to receive a group discount on a product or service, or the like. The system may, in some embodiments, permit the transfer of supplemental resources into a uniform category, even if they were originally designated for a different category, based on a conversion rate determined or set by the system.

Additionally, in some embodiments, the process 600 includes block 606, where the system causes a user interface of a computing device of the user to display the one or more resource opportunities and the one or more customized supplemental resources associated with each of the one or more resource opportunities. This display may represent a unified digital hub that can be updated in real time to provide up-to-date status information of a user's progress in completing a resource opportunity, the user's progress in growing a pool of supplemental resources toward a reward goal, new resource opportunities or reward goals that the user can meet or work toward, and the like. This digital hub may additionally include a communication feature whereby the user can communicate with a specialist at the managing entity, with another user (e.g., via a chat feature within a digital hub application on computing devices of the respective users), and the like. The communication feature may especially be helpful in allowing a user to collaborate with friends, family, or others with similar interests (e.g., affiliations with a charity to whom the users would like to donate supplemental rewards or gift an experience or product or service when their own reward goal(s) are met) to pool and aggregate supplemental resources for a collective reward goal.

The process 600 may also include block 608, where the system monitors user activity data associated with each of the one or more resource opportunities to determine that a first resource opportunity of the one or more resource opportunities has been completed.

In one embodiment, the system may determine the initiation of at least one or more customized opportunities by the user based on monitoring or communicating with the at least one user device of the user. Continuing with the previous example, the system may identify that the user is inside the merchant store for more than five minutes and may determine that the user initiated the resource opportunity associated with spending fifteen minutes at the merchant store. In another embodiment, the system determine the initiation of at least one or more customized opportunities by the user based on communicating with third party systems. Continuing with the previous example, the system may identify that the user initiated a conversation with a customer care representative about a particular product based on identifying an entry provided by the customer service representative to the third party system.

Additionally or alternatively, the system may monitor a transaction history of the user to determine when the user has completed a transaction with a particular merchant or a particular transaction type that is associated with a resource opportunity. Furthermore, the system may receive an indication from a merchant or other entity that the user has completed the resource opportunity (e.g., attended an event, referred another user, or the like).

In embodiments where the resource opportunity comprises participation in an educational program, the system may monitor the user's computing device to determine whether the user viewed an entirety of the educational program, whether the user achieved a review score on a related quiz that is indicative of participating in the educational program, whether the user was present at a physical location where the educational program took place, or the like.

In some embodiments, the process 600 includes block 610, where the system transmit a first customized supplemental resource of the one or more customized supplemental resources to the computing device of the user in response to determining that the at least one of the one or more resource opportunities is complete.

The system may determine that the user completed a resource opportunity and may transmit a notification comprising the supplemental resource amount or an animated message comprising the supplemental resource via the digital hub to the user device. In one embodiment, the system may notify the entity system or the merchant system to award the supplemental resource to a user based on identifying that the user has completed a resource opportunity. In such an embodiment, the system may receive the supplemental resource form the entity system or the merchant system and may then transmit the supplemental resource amount to the user device of the user (e.g., via the digital hub application). The system may then track the accumulation of the supplemental resources, including an accumulation of each type of supplemental resource the user holds (e.g., cash back points, travel reward points, universal reward points, and/or the like).

In some embodiments, the system may determine that multiple supplemental resources of the one or more customized supplemental resources are optionally available with the first resource opportunity. In some such embodiments, the system may cause the user interface of the computing device of the user to display selectable icons associated with each of the multiple supplemental resources that are optionally available with the first resource opportunity.

The system may then receive, from the user interface of the computing device of the user, user input of a selection of a first selectable icon of the displayed selectable icons. In response to receiving the user input of the selection of the first selectable icon, the system may designate an associated supplemental resource of the multiple supplemental resources that is optionally available with the first resource opportunity as the first customized supplemental resource.

Additionally, in some embodiments, the process 600 includes block 612, where the system dynamically calculates a total aggregated amount of customized supplemental resources of a same resource type as the first customized supplemental resource, including an amount of the first customized supplemental resource.

The system may constantly calculate the aggregated supplemental resources received or earned by the user based on completing the resource opportunities. The system may display a graphical representation of various categories of supplemental resources and total number of supplemental resources earned by the user. In response to receiving supplemental resource from the entity system or merchant system, the system may transmit the supplemental resource and may recalculate and update the aggregated supplemental resource value on the real time digital hub.

The system may, in some embodiments, dynamically modify the real-time user interface on the user device. For example, the system may modify the graphical representations of the aggregated supplemental resources and may display additional resource opportunities to the user. In one embodiment, the system may modify the real-time user interface after the identifying that the user has opened the notification provided by the system.

In some embodiments, the system may monitor the progress of the resource opportunity initiated by the user and may transmit a notification to the user device via the real-time digital hub. For example, when the resource opportunity is saving ‘X’ amount towards purchase of a house, the system may continuously monitor the resource opportunity to identify that 75% of the savings goal has been completed by the user and may transmit a “did you know” notification to the user.

In some embodiments, the system may monitor or calculate an aggregated supplemental resource amount value even after the user has utilized the rewards towards purchase of a product and may display both the existing supplemental rewards (which can be used by the user to purchase products) or service and the aggregated supplemental resource value to the user. This provides a value to the used rewards and expired rewards and allows the user to display the aggregated supplemental rewards or a universal score associated with the aggregated supplemental rewards to a merchant while purchasing a house, car, or the like. In some embodiments, when the reward is a product, the system may estimate the monetary value of the non-monetary product for calculating the aggregated supplemental resource value.

In some embodiments, the system may allow the user to transfer supplemental resource to a family member associated or linked to a resource pool of the user. In some embodiments, the system may allow family members to combine supplemental resources earned by each of the family members. In some embodiments, the system may allow the user to enroll in automatically transferring supplemental resources to an educational fund account. In some embodiments, the system may allow the user to transfer or combine the aggregated supplemental resources with supplemental resources of other resource pools associated with other third party entities or other financial institutions. For example, the system may allow the user to transfer airline rewards into the existing supplemental resources.

In some embodiments, the system may also provide one or more supplemental resources to merchants or group of businesses who are customers of the entity. In some embodiments, the system may allow the user to transmit a notification to the user device to utilize the existing supplemental resources based on identifying that the user has initiated a transaction. For example, the system may identify that the user is at a merchant store and has initiated a transaction, the system may provide a prompt on the user device or the POS device to utilize the rewards to pay for the transaction.

In some embodiments, the system may provide additional supplemental resources to users for participating in a donation day or a rewards day organized by the entity. For example, the system may provide rewards to users for donating to a list of charities affiliated to the entity or merchant associated with the entity on the donation day. In another example, the system may provide rewards to users for purchasing certain products using the reward points on a reward day.

In some embodiments, the system may provide supplemental resources for special occasions including, but not limited to, user birthday, bank anniversary with bank, or the like. In some embodiments, the system may identify that the user is planning a trip to Europe, the system may allow the user to convert the rewards to Euros or may allow the user to book hotels (associated with merchants who are customers of the entity) using the rewards. In some embodiments, the system may identify that the user is at a merchant location and may transmit a notification to the user device about incentives available for making a transaction at the merchant location.

The process 600 may include block 614, where the system determines that the total aggregated amount of customized supplemental resources of the same resource type as the first customized supplemental resource meets a predetermined threshold amount for a new event, wherein the new event is associated with the customized supplemental resources of the same resource type as the first customized supplemental resource. The new event may be the application of a particular discount, reduced interest rate, transmission of a charitable contribution, increase of a service level, or the like, as described herein. In some embodiments, the new event comprises a bid, lottery entry, or the like for an offered product or service. This type of new event may be beneficial to users that have not acquired enough supplemental rewards for a desired new event, and would otherwise not use the accumulated reward points, as the user can still have a chance to benefit from the new event.

Furthermore, the process 600 may include block 616, where the system causes the user interface of the computing device of the user to display a notification comprising a selectable icon for accepting the new event. For example, the system may transmit an alert that the new event is available to the user as a pop-up notification, an SMS text, an email message, or as a notification within the digital hub application on the computing device of the user.

Finally, the process 600 may continue to block 618, where the system, in response to receiving an indication that the selectable icon for accepting the new event has been selected, executes the new event. Executing the event may comprise transmitting funds to a the user, transmitting funds as a donation to a charitable organization, lowering an interest rate for a loan product, upgrading a user's service level, communicating with a merchant to establish a reduced rate or improved service level for the user, or any other action that the managing entity would need to take to effect the rewarded event selected by the user.

As an example of the process 600 described herein, at least one of the resource opportunities available to the user may comprise a transaction at a merchant with an affiliation with a charity. This resource opportunity and this merchant may be identified or selected by the system based on a determination (e.g., based on a historical donation transaction history of the user) that the user has an affiliation (e.g., donor, representative, member, or the like), to the same charity or type of charity that the merchant has an affiliation with. In such embodiments, the supplemental resources may be customized to be based on a transaction at the merchant with the affiliation with the charity.

For example, the supplemental resources may comprise a donation amount to the charity that is a percentage of a transaction with the merchant and/or fixed amount that would be donated in response to the transaction with the merchant. As such, the new event of the process 600 may comprise the transfer of the donation amount from the merchant to the charity in response to determining that the user has conducted a transaction with the merchant, and the predetermined threshold amount for this new event (i.e., the charitable donation) comprises any amount greater than zero (i.e., there is a donation amount to transfer to the charity).

In another example of the process 600 described herein, a resource opportunity available to the user may comprise participation in an educational course associated with a product or service of a merchant or a managing entity. The educational course may be an online course, a mobile application course, a live course, a presentation, a quiz, a test, and/or the like. The supplemental resources available to the user based on the user's participation in the educational course may be tied to the subject matter of the educational course itself. For example, if the educational course is associated with financial planning, budgeting for automobile loans, or the like, the supplemental resources associated with the user participating in the educational course may comprise a decreased interest rate associated with a product or service of a merchant or managing entity. This type of reward is especially beneficial to both the user and a merchant or managing entity when it promotes prompt and timely payments of loans, as the merchant or managing entity is more likely to receive all payments and the user is able to have the benefit of a reduced amount of interest. Similarly, if the educational course is related to the use or promotion of a product or service of a merchant or the managing entity, the customized supplemental resource may comprise a discount on a product or service of the merchant or managing entity. In such embodiments, the predetermined threshold amount for the new event could be any non-zero discount offer amount or decreased interest rate amount.

Although many embodiments of the present invention have just been described above, the present invention may be embodied in many different forms and should not be construed as limited to the embodiments set forth herein. Rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein. In some embodiments, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for providing an interactive real-time digital hub for processing supplemental resources, the system comprising:
a memory device; and
a processing device operatively coupled to the memory device, wherein the processing device is configured to execute computer-readable program code to:
determine one or more resource opportunities available to a user;
determine one or more customized supplemental resources associated with each of the one or more resource opportunities, wherein each of the one or more customized supplemental resources associated with each of the one or more resource opportunities comprises a universal supplemental resource amount or a supplemental resource that is directly related to an associated resource opportunity of the one or more resource opportunities;
cause a user interface of a computing device of the user to display the one or more resource opportunities and the one or more customized supplemental resources associated with each of the one or more resource opportunities;
monitor user activity data associated with each of the one or more resource opportunities to determine that a first resource opportunity of the one or more resource opportunities has been completed;
in response to determining that the at least one of the one or more resource opportunities is complete, transmit a first customized supplemental resource of the one or more customized supplemental resources to the computing device of the user;
dynamically calculate a total aggregated amount of customized supplemental resources of a same resource type as the first customized supplemental resource, including an amount of the first customized supplemental resource;
determine that the total aggregated amount of customized supplemental resources of the same resource type as the first customized supplemental resource meets a predetermined threshold amount for a new event, wherein the new event is associated with the customized supplemental resources of the same resource type as the first customized supplemental resource;
cause the user interface of the computing device of the user to display a notification comprising a selectable icon for accepting the new event; and
in response to receiving an indication that the selectable icon for accepting the new event has been selected, execute the new event.

2. The system of claim 1, wherein the processing device is further configured to execute computer-readable program code to:
determine that multiple supplemental resources of the one or more customized supplemental resources are optionally available with the first resource opportunity;
cause the user interface of the computing device of the user to display selectable icons associated with each of the multiple supplemental resources that are optionally available with the first resource opportunity;
receive, from the user interface of the computing device of the user, user input of a selection of a first selectable icon of the displayed selectable icons; and
in response to receiving the user input of the selection of the first selectable icon, designate an associated supplemental resource of the multiple supplemental resources that is optionally available with the first resource opportunity as the first customized supplemental resource.

3. The system of claim 1, wherein at least one of the one or more resource opportunities available to the user comprises a transaction at a merchant with an affiliation with a charity, wherein at least one of the one or more customized supplemental resources associated with the transaction at the merchant with the affiliation with the charity comprises a donation amount to the charity, wherein the new event comprises a transfer of the donation amount from the merchant to the charity, and wherein the predetermined threshold amount for the new event comprises any amount greater than zero.

4. The system of claim 1, wherein at least one of the one or more resource opportunities available to the user comprises participation in an educational course associated with a product or service of a merchant or a managing entity, wherein at least one of the one or more customized supplemental resources associated with the participation in the educational course comprises a transaction discount offer or a decreased interest rate associated with the product or service of the merchant or the managing entity, wherein the new event comprises applying the transaction discount offer or the decreased interest rate to the product or service of the merchant or the managing entity, and wherein the predetermined threshold amount for the new event comprises any non-zero discount offer amount or decreased interest rate amount.

5. The system of claim 1, wherein at least one of the one or more customized supplemental resources associated with the first resource opportunity comprises collective supplemental resources that can be aggregated between the user and other members of a group that the user is in, wherein the total aggregated amount of customized supplemental resources of the same resource type as the first customized supplemental resource additionally includes amounts of supplemental resources acquired by the other members of the group that the user is in.

6. The system of claim 1, wherein the new event comprises a bid for an offered product or service.

7. The system of claim 1, wherein at least one of the one or more resource opportunities available to the user comprises a task associated with an internet of things device, wherein the task comprises a measurable fitness achievement, a measurable energy consumption achievement, or a measureable geographic location-based achievement.

8. The system of claim 1, wherein at least one of the one or more resource opportunities available to the user comprises a period of time associated with increased values for the one or more customized supplemental resources.

9. A computer program product for providing an interactive real-time digital hub for processing supplemental resources, the computer program product comprising at least one non-transitory computer readable medium comprising computer readable instructions, the instructions comprising instructions for:
determining one or more resource opportunities available to a user;
determining one or more customized supplemental resources associated with each of the one or more resource opportunities, wherein each of the one or more customized supplemental resources associated with each of the one or more resource opportunities comprises a universal supplemental resource amount or a supplemental resource that is directly related to an associated resource opportunity of the one or more resource opportunities;
causing a user interface of a computing device of the user to display the one or more resource opportunities and the one or more customized supplemental resources associated with each of the one or more resource opportunities;
monitoring user activity data associated with each of the one or more resource opportunities to determine that a first resource opportunity of the one or more resource opportunities has been completed;
in response to determining that the at least one of the one or more resource opportunities is complete, transmitting a first customized supplemental resource of the one or more customized supplemental resources to the computing device of the user;
dynamically calculating a total aggregated amount of customized supplemental resources of a same resource type as the first customized supplemental resource, including an amount of the first customized supplemental resource;
determining that the total aggregated amount of customized supplemental resources of the same resource type as the first customized supplemental resource meets a predetermined threshold amount for a new event, wherein the new event is associated with the customized supplemental resources of the same resource type as the first customized supplemental resource;
causing the user interface of the computing device of the user to display a notification comprising a selectable icon for accepting the new event; and
in response to receiving an indication that the selectable icon for accepting the new event has been selected, executing the new event.

10. The computer program product of claim 9, wherein the computer readable instructions further comprise instructions for:
determining that multiple supplemental resources of the one or more customized supplemental resources are optionally available with the first resource opportunity;
causing the user interface of the computing device of the user to display selectable icons associated with each of the multiple supplemental resources that are optionally available with the first resource opportunity;
receiving, from the user interface of the computing device of the user, user input of a selection of a first selectable icon of the displayed selectable icons; and
in response to receiving the user input of the selection of the first selectable icon, designating an associated supplemental resource of the multiple supplemental resources that is optionally available with the first resource opportunity as the first customized supplemental resource.

11. The computer program product of claim 9, wherein at least one of the one or more resource opportunities available to the user comprises a transaction at a merchant with an affiliation with a charity, wherein at least one of the one or more customized supplemental resources associated with the transaction at the merchant with the affiliation with the charity comprises a donation amount to the charity, wherein the new event comprises a transfer of the donation amount from the merchant to the charity, and wherein the predetermined threshold amount for the new event comprises any amount greater than zero.

12. The computer program product of claim 9, wherein at least one of the one or more resource opportunities available to the user comprises participation in an educational course associated with a product or service of a merchant or a managing entity, wherein at least one of the one or more customized supplemental resources associated with the participation in the educational course comprises a transaction discount offer or a decreased interest rate associated with the product or service of the merchant or the managing entity, wherein the new event comprises applying the transaction discount offer or the decreased interest rate to the product or service of the merchant or the managing entity, and wherein the predetermined threshold amount for the new event comprises any non-zero discount offer amount or decreased interest rate amount.

13. The computer program product of claim 9, wherein at least one of the one or more customized supplemental resources associated with the first resource opportunity comprises collective supplemental resources that can be aggregated between the user and other members of a group that the user is in, wherein the total aggregated amount of customized supplemental resources of the same resource type as the first customized supplemental resource additionally includes amounts of supplemental resources acquired by the other members of the group that the user is in.

14. The computer program product of claim 9, wherein the new event comprises a bid for an offered product or service.

15. The computer program product of claim 9, wherein at least one of the one or more resource opportunities available to the user comprises a task associated with an internet of things device, wherein the task comprises a measurable fitness achievement, a measurable energy consumption achievement, or a measureable geographic location-based achievement.

16. A computer implemented method for providing an interactive real-time digital hub for processing supplemental resources, said computer implemented method comprising:
providing a computing system comprising a computer processing device and a non-transitory computer readable medium, where the computer readable medium comprises configured computer program instruction code, such that when said instruction code is operated by said computer processing device, said computer processing device performs the following operations:
determining one or more resource opportunities available to a user;
determining one or more customized supplemental resources associated with each of the one or more resource opportunities, wherein each of the one or more customized supplemental resources associated with each of the one or more resource opportunities comprises a universal supplemental resource amount or a supplemental resource that is directly related to an associated resource opportunity of the one or more resource opportunities;
causing a user interface of a computing device of the user to display the one or more resource opportunities and the one or more customized supplemental resources associated with each of the one or more resource opportunities;
monitoring user activity data associated with each of the one or more resource opportunities to determine that a first resource opportunity of the one or more resource opportunities has been completed;
in response to determining that the at least one of the one or more resource opportunities is complete, transmitting a first customized supplemental resource of the one or more customized supplemental resources to the computing device of the user;
dynamically calculating a total aggregated amount of customized supplemental resources of a same resource type as the first customized supplemental resource, including an amount of the first customized supplemental resource;
determining that the total aggregated amount of customized supplemental resources of the same resource type as the first customized supplemental resource meets a predetermined threshold amount for a new event, wherein the new event is associated with the customized supplemental resources of the same resource type as the first customized supplemental resource;
causing the user interface of the computing device of the user to display a notification comprising a selectable icon for accepting the new event; and
in response to receiving an indication that the selectable icon for accepting the new event has been selected, executing the new event.

17. The computer implemented method of claim 16, wherein the computer readable instructions further comprise instructions for:
determining that multiple supplemental resources of the one or more customized supplemental resources are optionally available with the first resource opportunity;
causing the user interface of the computing device of the user to display selectable icons associated with each of the multiple supplemental resources that are optionally available with the first resource opportunity;
receiving, from the user interface of the computing device of the user, user input of a selection of a first selectable icon of the displayed selectable icons; and
in response to receiving the user input of the selection of the first selectable icon, designating an associated supplemental resource of the multiple supplemental resources that is optionally available with the first resource opportunity as the first customized supplemental resource.

18. The computer implemented method of claim 16, wherein at least one of the one or more resource opportunities available to the user comprises a transaction at a merchant with an affiliation with a charity, wherein at least one of the one or more customized supplemental resources associated with the transaction at the merchant with the affiliation with the charity comprises a donation amount to the charity, wherein the new event comprises a transfer of the donation amount from the merchant to the charity, and wherein the predetermined threshold amount for the new event comprises any amount greater than zero.

19. The computer implemented method of claim 16, wherein at least one of the one or more resource opportunities available to the user comprises participation in an educational course associated with a product or service of a merchant or a managing entity, wherein at least one of the one or more customized supplemental resources associated with the participation in the educational course comprises a transaction discount offer or a decreased interest rate associated with the product or service of the merchant or the managing entity, wherein the new event comprises applying the transaction discount offer or the decreased interest rate to the product or service of the merchant or the managing entity, and wherein the predetermined threshold amount for the new event comprises any non-zero discount offer amount or decreased interest rate amount.

20. The computer implemented method of claim 16, wherein at least one of the one or more resource opportunities available to the user comprises a task associated with an internet of things device, wherein the task comprises a measurable fitness achievement, a measurable energy consumption achievement, or a measureable geographic location-based achievement.
